(19) United States
(12) Patent Application Publication
(10) Pub. No.: US 2007/0172140 A1
(43) Pub. Date: Jul. 26, 2007

(54) Selective enhancement of digital images

(76) Inventor: Nils Kokemohr, Hamburg (DE)

Correspondence Address: NIK SOFTWARE, INC.;c/o SHELDON MAK ROSE & ANDERSON, 100 EAST CORSON STREET, THIRD FLOOR, PASADENA, CA, 91103-3842, US

(21) Appl. No.: 10/550,364

(22) PCT Filed: Mar. 19, 2004
(86) PCT No.: PCT/US04/08473

§ 371 Date: Jan. 23, 2007

Related U.S. Application Data
(60) Provisional application No. 60/456,150, filed on Mar. 19, 2003.

(51) Int. Cl. G06K 9/40

(52) U.S. Cl. 382/261

(57) ABSTRACT

A method for image processing of a digital image is described comprising applying an image processing filter (17) as a function of the correspondence between each pixel in the image and a first target image characteristic (12) and a second target image characteristic (13). In a further embodiment, a method is described comprising applying an image processing filter as a function of the correspondence between each pixel, the received target image characteristic, and the input received from a user pointing device. A system and application user interface is also described.

### CROSS REFERENCE TO RELATED APPLICATION

This application claims the benefit of U.S. provisional application Ser. No. 60/456,150 filed Mar. 19, 2003, titled “System for Selective Noise Reduction and Enhancement of Digital Images.”

### BACKGROUND

It is a well-known problem that noise in digital images is present throughout the image. While noise may appear more in certain attributes of a digital image, e.g., against sky, skin, background, etc., noise may not be as visible when present against other detail types.

Currently available noise reduction processes address noise reduction from a global perspective (applying noise reduction to an entire image) often softening the image to an undesirable degree. Such problems exist both for luminance noise and chrominance noise. There are regions in images (such as dark hair and shadows) where luminance noise does not distract from the photographic qualities of the image and are often not perceived as noise. Chrominance noise, however, is more visible in the same areas and must be reduced differently.

Most users of image editing applications face difficulties with “targeting” certain areas in an image. For example, a user who wants to sharpen the plant in the foreground of an image, but not the sky in the background of the image, faces a challenging task. In common image editing applications, such as Adobe Photoshop®, the user would have to create a “selection” for the plant, before applying an image enhancement filter, for instance, a sharpening filter. Typically, the user has to “draw” the selection using a pointing device, such as a computer mouse, around the plant. Only after creating such a selection, can the user sharpen the plant.

Further, the user often wants to sharpen the plant to a high degree and the background to a lower degree. To do so, the user would first have to select the plant, sharpen it to a high degree, then select everything else but the plant, and sharpen this to a lower degree. In another example, given the case that there is a person in the given image and the user wants to sharpen the plants in the image to a high extent, the background to a low extent, and the hair and the skin of the person in the image to a medium extent, using selections with conventional applications becomes a highly challenging task.

Selecting an area in an image is a difficult task Therefore, image editing applications such as Adobe Photoshop® offer a variety of different selection methods, all of which have a steep learning curve. What is needed is a method and system to make selective enhancement an image easier, and which would be applicable for all types of image enhancement filters, such as sharpening, noise reduction, contrast changes, conversion to black and white, color enhancement etc. Such a method and system would provide for a range of image enhancements on a selective basis. Preferably, such a method and system would be able to process a digital image by applying an image processing filter as a function of multiple image characteristics, or as a function of an image characteristic and the input from a user pointing device.

### SUMMARY

The disclosed method and system meets this need by providing for a range of image enhancements on a selective basis. The method and system is able to process a digital image by applying an image processing filter as a function of multiple target image characteristics, or in a further embodiment, as a function of target image characteristic and the input from a user input device.

A method for image processing of a digital image comprising pixels having characteristics is disclosed, comprising applying an image processing filter as a function of the correspondence between each pixel and a first target image characteristic and a second target image characteristic.

A method for image processing of a digital image comprising pixels having characteristics is disclosed, comprising the steps of providing an image processing filter, receiving first target image characteristics, receiving second target image characteristics, determining for each pixel to be processed, the correspondence between the characteristics of that pixel and the first target image characteristics and second target image characteristics and processing the digital image by applying the image processing filter as a function of the determined correspondence between each pixel and the first target image characteristics and second target image characteristics. In various embodiments, the image processing filter may be, for example, a noise reduction filter, a sharpening filter, or a color change filter.

In a further embodiment, an adjustment parameter may be received, and then the application of the image processing filter is also a function of the adjustment parameter. In various embodiments the adjustment parameter may be an opacity parameter or a luminosity parameter.

In still further embodiments a graphic user interface may be provided for receiving the first target image characteristics, the second target image characteristics, and optionally the adjustment parameter. The graphic user interface for receiving the adjustment parameter optionally may comprise a slider.

In various embodiments the first target image characteristics, or the second target image characteristics, may be an image coordinate, a color, or an image structure, and indicia may be used to represent target image characteristics.

In a still further embodiment, the graphic user interface comprises a tool to determine the pixel characteristics of an image pixel.

In a further embodiment, a camera-specific default settings are provided.

An application program interface is disclosed, embodied on a computer-readable medium for execution on a computer for image processing of a digital image, the digital image comprising pixels having characteristics, comprising a first interface to receive first target image characteristics, a second interface to receive second target image characteristics, a third interface to receive a first adjustment parameter corresponding to the first target image characteristics, and a fourth interface to receive a second adjustment parameter corresponding to the second target image characteristics. Optionally, a fifth interface comprising indicia representing the first target image characteristics, and a sixth interface comprising indicia representing the second target image characteristics, may be added. A tool to determine the pixel characteristics of an image pixel may also be added to the interface, and optionally, the third interface and the fourth interface may each comprise a slider.

A system for image processing of a digital image is disclosed, the digital image comprising pixels having characteristics, comprising a processor, a memory in communication with the processor, and a computer readable medium in communication with the processor, the computer readable medium having contents for causing the processor to perform the steps of receiving first target image characteristics, receiving second target image characteristics, determining for each pixel to be processed, the correspondence between the characteristics of that pixel and the first target image characteristics and second target image characteristics, and processing the digital image by applying the image processing filter as a function of the determined correspondence between each pixel and the first target image characteristics and second target image characteristics.

Optionally, the computer readable medium further has contents for causing the processor to perform the steps of receiving a first adjustment parameter corresponding to the first target image characteristics and receiving a second adjustment parameter corresponding to the second target image characteristics. In a further embodiment, he system of claim further comprises a set of camera-specific default instructions embodied on a computer-readable medium for execution on a computer.

A set of camera-specific default instructions embodied on a computer-readable medium is disclosed, for execution on a computer for image processing of a digital image, using one of the embodiments of the method of the invention. The set of camera-specific default instructions may set the state of the application program interface.

A method for image processing of a digital image comprising pixels having characteristics is disclosed, comprising applying an image processing filter as a function of the correspondence between each pixel, the received target image characteristic, and the input received from a use pointing device.

A method for image processing of a digital image comprising pixels having characteristics is disclosed, comprising the steps of providing an image processing filter, receiving a target image characteristic, receiving a coordinate from a user pointing device, determining for each pixel to be processed, the correspondence between the characteristics of that pixel, the target image characteristics, and the received coordinates, and processing the digital image by applying the image processing filter as a function of the determined correspondence between each pixel, the target image characteristic, and the received coordinates. In various embodiments the image processing filter may be, for example, a noise reduction filter, a sharpening filter, or a color change filter. A graphic user interface for receiving the target image characteristic may be used, and optionally the graphic user interface may comprise indicia representing the target image characteristic. Example target image characteristics include an image coordinate, a color, or an image structure.

An application program interface embodied on a computer-readable medium for execution on a computer for image processing of a digital image is disclosed, the digital image comprising pixels having characteristics, comprising a first interface to receive a target image characteristic; and a second interface to receive a coordinate from a user pointing device.

A system for image processing of a digital image is disclosed, the digital image comprising pixels having characteristics, comprising a processor, a memory in communication with the processor, a user pointing device, and a computer readable medium in communication with the processor, the computer readable medium having contents for causing the processor to perform the steps of receiving a target image characteristic, receiving coordinates from a user pointing device, determining for each pixel to be processed, the correspondence between the characteristics of that pixel, the target image characteristics, and the received coordinates, and processing the digital image by applying the image processing filter as a function of the determined correspondence between each pixel, the target image characteristic and received coordinates.

### DRAWINGS

These and other features, aspects, and advantages of the present invention will become better understood with reference to the following description, appended claims, and accompanying drawings, where:

FIG. 1 is a depiction one embodiment of an application user interface suitable for use according to the invention.

FIG. 2 is a depiction another embodiment of an application user interface suitable for use according to the invention.

FIG. 3 is a depiction one embodiment of an application user interface suitable for use according to a further embodiment of the invention.

FIG. 4 is a depiction of a user interface showing application of the invention.

FIG. 5 is a pictorial diagram of components usable with the system for enhancing digital images according to the present invention.

FIG. 6 is a pictorial diagram of the image sources useable for acquiring a digital image to be enhanced according to the present invention.

FIG. 7 is a block diagram of an embodiment of the method of the invention.

FIG. 8 is a block diagram of a further embodiment of the method of the invention.

FIG. 9 is a block diagram of an embodiment of the system of the invention.

FIG. 10 is a block diagram of a further embodiment of the system of the invention.

### DETAILED DESCRIPTION

The method and program interface of the present invention is useable as a plug-in supplemental program, as an independent module that may be integrated into any commercially available image processing program such as Adobe Photoshop®, or into any image processing device that is capable of modifying and displaying an image, such as a color copier or a self service photo print kiosk, as a dynamic library file or similar module that may be implemented into other software programs whereby image measurement and modification may be useful, or as a stand alone software program. These are all examples, without limitation, of image processing of a digital image. Although embodiments of the invention which adjust color, contrast, noise reduction, and sharpening are described, the present invention is useful for altering any attribute or feature of the digital image.

Furthermore, it will become clear with regard to the current invention that the user interface for the current invention may have various embodiments, which will become clear later in this disclosure.

The present invention is also useable with a method and system incorporating user definable image reference points, as disclosed in U.S. Pub. No. US 2003-0099411 A1, Ser. No. 10/280,897, for “User Definable Image Reference Points”, which disclosure is expressly incorporated herein by reference.

The Application Program Interface

The present invention, in its various embodiments, permits the selection of areas of a digital image for enhancement. In preferred embodiments, a user interface component is present. Those skilled in the art will find that multiple methods or implementations of a user interface are useful with regard to the current invention.

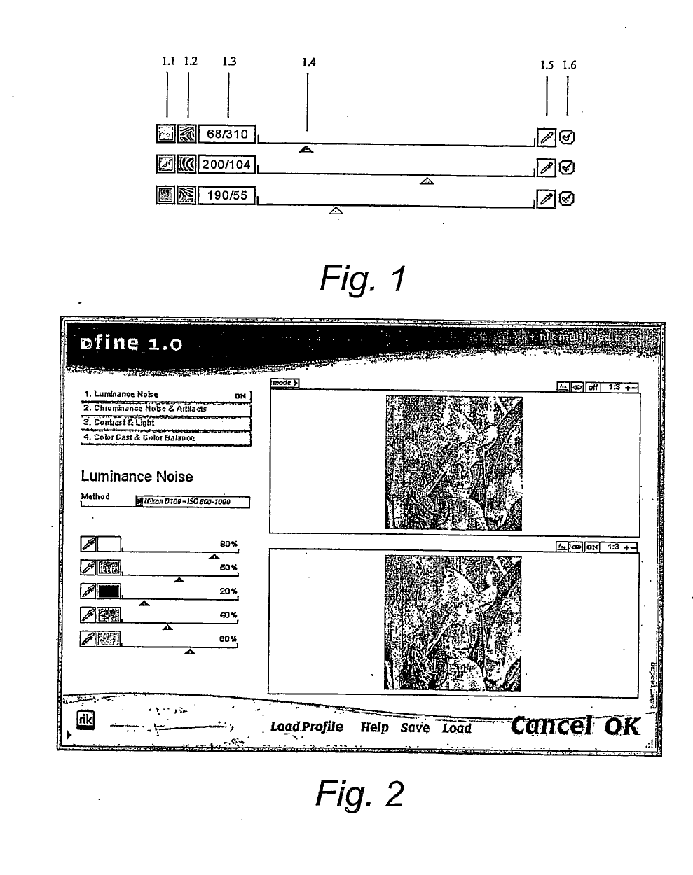

In one preferred embodiment of a user interface useable with the present invention, the interface allows the user to set a variety of types of image modifications in an image, which can be shown as graphic sliders, as shown in FIG. 1. The sliders could be implemented in a window which floats above the image, as will be evident to those skilled in the art with reference to this disclosure. In one preferred embodiment, with reference to FIG. 2, the sliders are implemented in a window containing zoom enabled previews of the image, before and after application of the image enhancement. In the embodiment shown in FIG. 2, a plurality of sliders are available, so that the chosen image enhancement can operate as a function of these multiple inputs.

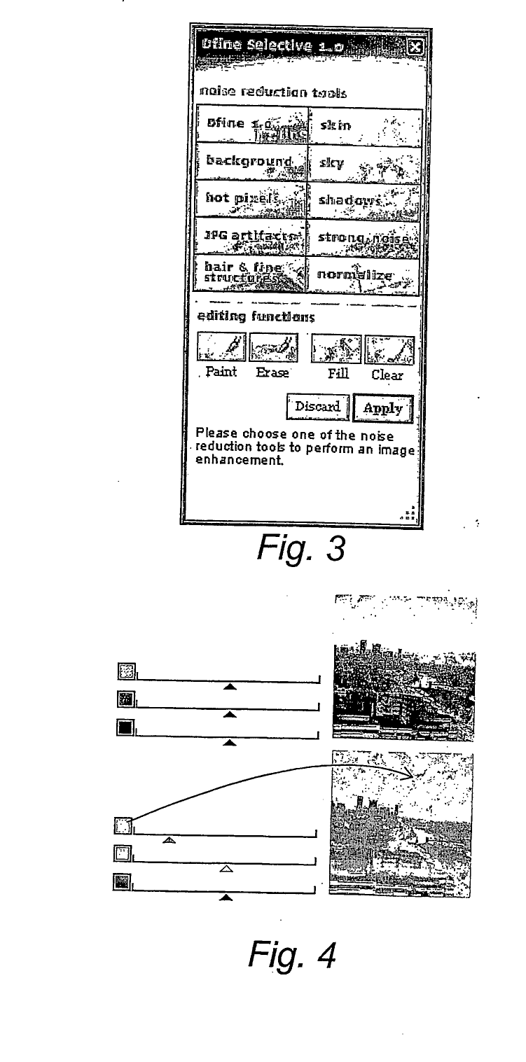

In another embodiment, with reference to FIG. 3, a plurality of image characteristics are listed, and the user may choose to apply the chosen image enhancement (noise reduction in the case of FIG. 3) to the area selected. For example, by choosing “skin” from the table menu, the user can paint on the noise reduction filter, and only skin areas will be modified. In the optional further embodiment shown, erase, fill, and clear operations are available.

The application program interface is embodied on a computer-readable medium for execution on a computer for image processing of a digital image. The interface receives the characteristics of the image which the user desires to select. In a further embodiment, a second interface receives an image editing function assigned by the user.

Selective Enhancement Using a Selective Application Matrix

With reference to FIGS. 1 and 2, the plurality of sliders and graphic icons are inputs to a matrix, which for convenience we can describe as a Selective Application Matrix, abbreviated to SAM As will be evident to those skilled in the art, other types of controllers are also possible as inputs to the SAM. There are at least two, and typically five or more, SAM controllers.

Preferably, the SAM controllers are displayed next to the image, and each SAM controller is linked to a region in the image. The regions may be described in a variety of ways. In one preferred method the regions are described by image feature; for example, the first SAM controller may be linked to sky, and the second may be linked to grass (not shown).

As is evident from FIG. 1 and FIG. 2, the SAM controller may have an associated numerical input interface to set an adjustment parameter for filter opacity, strength, or other variable. In a preferred embodiment a slider is used, but direct input or other interfaces are possible. In the previous sky/grass example, if the user sets the first SAM controller adjustment parameter to 80% and the second controller is set to 20%, the selected filter will be applied to 80% strength to the sky and to 20% strength to the grass. If the filter is a sharpening filter, the sly would be sharpened to 80% and the grass to 20%. The same would occur for a filter that increases the saturation, reduces noise, or enhances the contrast. As a further example, the filter could be a filter that turns a color image into a black and white image, where the sliders would control the tonality in the image, so that in the black and white image the sky would have an 80% tonality (dark) and the grass would have a 20% tonality (being bright).

The SAM may be used for the purposes of noise reduction, image sharpening, or any other image enhancement, where it is desired to be able to selectively apply the image enhancement.

With reference to FIG. 1, each SAM controller in that embodiment is represented by a set of icons and a slider for the adjustment parameter. Each of the SAM controllers is accompanied by one or more fields (1.1, 1.2 and 1.3) that can represent target image characteristics. In FIG. 1, icon 1.1 represents a color, icon 1.2 represents an image structure, and icon 1.3 holds an image coordinate. In one embodiment, the color can be a RGB value, a structure can be a value derived from the difference of adjacent pixels (such as the mean luminosity difference of horizontally adjacent pixels, or local wavelet, or Fourier components), and an image coordinate could be an X and a Y coordinate.

If the first slider is supposed to be “linked” with the sky (how the user creates such a “link” will be described below), then the color icon 1.1 would contain a color that represents the sky (saturated blue), the structure field would contain data that represents the structure of sky (a very plain structure), and the coordinate field would represent a location somewhere in the sky (top of the image). The same principle applies for the second SAM controller, which may, for example, be linked to the “grass” (green, high detail structure, bottom of image).

The user can either set these values in icons 1.1 through 1.3 manually (such as by clicking on the icon and then selecting a color or a structure from a palette, or by entering the value via the keyboard), or the user can use the eyedropper (see icon 1.5 in FIG. 1). Once the user clicks on the eyedropper, he can then click in the image. Once he clicks in the image, the software will then read the color, structure and the coordinate, and fill these values into the icons 1.1 to 1.3. Optionally, as shown a check box 1.6 can be provided to select or deselect an given SAM controller.

Not all embodiments require all of the icons 1.1, 1.2, and 1.3; at least one of them is sufficient. For example, in FIG. 4, each SAM controller comprises one icon and one slider for a parameter adjustment.

Any user control that enables the user to define a value can be used. This could be a field where the user can enter a number via the keyboard, a wheel that can be rotated like a volume control on an amplifier, or other implementations.

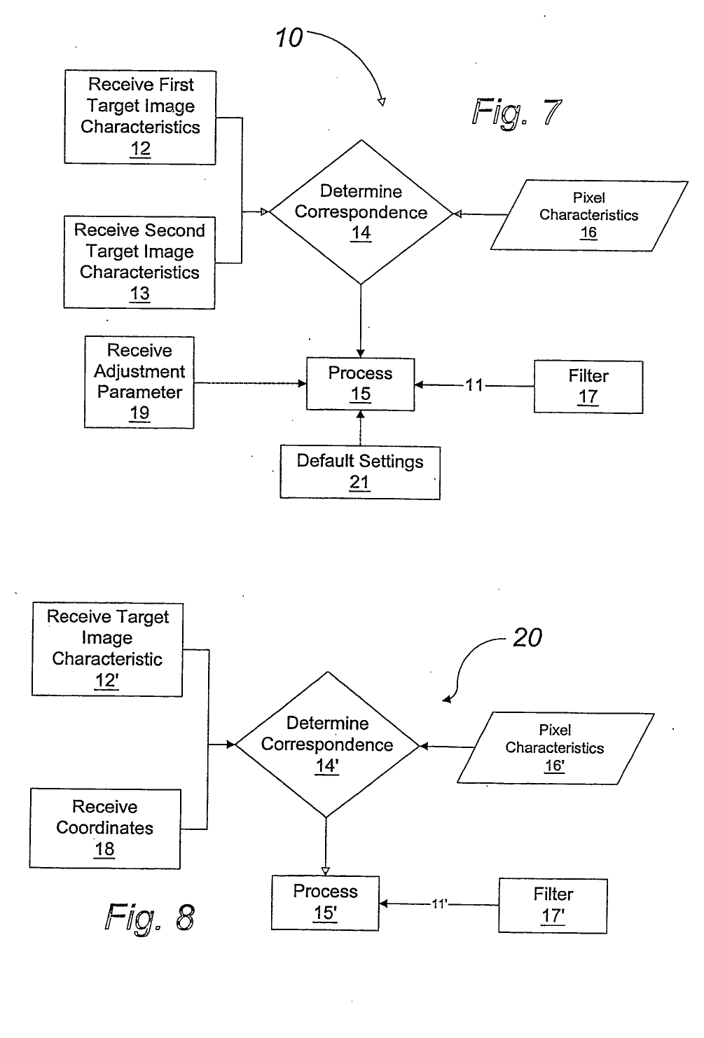

With reference to FIG. 7, a digital image can then be processed using method 10:
11) provide an image processing filter 17;
12) receive first target image characteristics;
13) receive second target image characteristics;
14) determine for each pixel to be processed, the correspondence between the characteristics 16 of that pixel and the first target image characteristics and second target image characteristics; and
15) process the digital image by applying the image processing filter as a function of the determined correspondence between each pixel and the first target image characteristics and second target image characteristics.

In one embodiment, for each pixel to be processed, the SAM controller whose characteristics match the given pixel best is determined, and using that controller's values as inputs for the filter, the pixel is modified.

In a further embodiment, a step can be added to receive 19 an adjustment parameter and apply the filter 17 as a function of the adjustment parameter. In a still further embodiment, camera-specific default settings are provided 21 as described herein.

For example, where the user wants to sharpen a plant with 80% strength and the sky in the background with 20% strength, this algorithm would identify some pixels in the image to match the characteristics of the SAM controller set to the plant and sharpen those pixels with 80%. Other pixels would be identified to match the SAM controller set to the sky and would then be sharpened with 20%, and still others might not identify with either and might not be sharpened.

In order to avoid harsh transitions, definable image reference points could be used to allow for soft transitions from one area to another, as disclosed in U.S. Pub. No. US 2003-0099411 A1, Ser. No. 10/280,897, for “User Definable Image Reference Points.” (That disclosure is expressly incorporated herein.) This would be preferred for filters that change luminosity or color, as the soft transitions provide a higher image quality. In filters such as noise reduction or sharpening, speed of processing may be more important.

The SAM can be used in many different ways. The filter can be any image enhancement, and the values of the adjustment parameter can be any dominant parameter of that filter. The filters can be color enhancement, noise reduction, sharpening, blurring, or other filter, and the values of the adjustment parameter can control the opacity, the saturation, or the radius used in the filter.

In still further embodiments, the filters can be a conversion to black and white or a filter that raises the contrast. In such a filter the user may want to make certain areas a little darker while applying the filter, while brightening other areas. The SAM would then be implemented in a way that the value provided for each pixel in the named algorithm is used to darken or lighten the pixel to a certain extent.

Any filter known in the field of image editing, and any parameter of that filter can be controlled by a SAM.

Calculating A Selective Application Matrix

As an example of how the application user interface can be used with a filter will be described. In this embodiment, with reference to FIG. 1, the user can click on one of the icons representing target image characteristics, such as color icon 1.1, and redefine the color that is associated with the associated slider 1.4. In the following equation, these n colors will be referred to as C₁ . . . Cₙ. The setting of a slider (i.e., the desired noise reduction for the color of the slider) will be referred to as S₁ . . . Sₙ. It is preferable to normalize S₁ . . . Sₙ so that it ranges from 0.0 to 1.0, where 1.0 represents 100% noise reduction.

The desired value S_{xy} can be calculated for each pixel in the image as follows:

$${S}_{xy} = {\sum }_{i = 1}^{n} \frac{{S}_{i} V ( \vert {C}_{i , 1} - {C}_{Ixy , 1} \vert + … + \vert {C}_{i , m} - {C}_{Ixy , m} \vert )}{{\sum }_{u = 1}^{n} V ( \vert {C}_{u , 1} - {C}_{Ixy , 1} \vert + … + \vert {C}_{u , m} - {C}_{Ixy , m} \vert )}$$

Where:

S_{xy} is the value to be calculated for each pixel xy in the image I, ranging from MIN to MAX, to represent for example the opacity of a noise reduction algorithm applied.

n is the amount of sliders that are offered, such as 3 in the given examples.

m is the amount of target image characteristics that are used in the process.

V is an inversion function, such as V(x)=1/x, e^{-x}^{²}, 1/x², etc.

Sᵢ is the value of the i-th slider, ranging from MIN to MAX.

C_{i,j} and C_{Ixy,j} are characteristics of a pixel or a slider, C_{i,j} being the j^{th} characteristics of the i^{th} slider, C_{Ixy,j} being the j^{th} characteristic of the pixel I_{xy}.

The characteristics C can be directly derived from the values received from the target image characteristic icons 1.1, 1.2, and 1.3 as shown in FIG. 1. If the coordinates icon 1.3 is provided, the list of characteristics C_{i,I} . . . . C_{i,j} will at least include one target image characteristic for the horizontal, and one target image characteristic for the vertical coordinate. If a color icon 1.1 or a structure icon 1.2 is provided, additional characteristics will be derived from those fields. Note: To implement a SAM, not all characteristic fields 1.1, 1.2, or 1.3, as shown in FIG. 1, are required.

This principle can be used for filters like sharpening, noise reduction, color warming, and other filters where it is desirable to control the opacity of one filter.

The SAM can also be used to provide advanced input parameters to a filter. If a filter F′ has one parameter z that the user may want to vary throughout the image, such as I′_{xy}=F′ (I,x,y,z), this parameter z can be replaced with S_{xy} in order to vary the effect of the filter F′.

Such a filter F′ could be a blurring effect, and the parameter z could be a radius. In that case, the sliders would probably reach from 0.0 (MIN) to, for instance, 4.0 (MAX), so that Ss is a radius between 0.0 and 4.0. The blurring filter F(I,x, y,S_{wy}) would then blur the pixels of the image depending on the variable S_{xy}, which varies from pixel to pixel. With this technique, the user can blur the image with different radii at different areas. For example, if there were only two sliders and the user “linked” one slider to the sky and set its value to 3.5, and if the user “linked” the second slider with the face in the foreground and set its value to 0.5, the filter would blur the sky with a radius of 3.5, the face with a radius of 0.5, and other parts of the image with varying radii between 0.5 and 3.5.

Another example for such a filter F′ could be any complex image filter with many parameters in addition to z, such as a conversion to black and white, a relief effect, a painterly effect, an increase of contrast, etc. Many of such artistic or photographic filters often create “fall off areas” or “blown out areas.” A “fall off area” is an area in the image that is completely black (large area of zero values) after the filter is applied, and a “blown out area” is an area that is purely white. Neither effect is wanted. For instance, if the filter applies a brightening effect, areas that were “almost white” before filtering may easily become pure white after filtering. In such case it is desirable that this area be darkened while filtering. This could be done, for instance, by setting the lowest possible setting of the n sliders W) to a negative value and the highest possible setting of the n sliders (MAX).to the same positive value, such as −50 and 50, so that S_{xy} varies from −50 to 50 for each pixel on the image. The user could connect one of the sliders to that area that was almost white before filtering, and set the sliders value to below zero. The filter F′(I, x, y, z) would then receive a low value for z in this area and therefore lower the luminosity in this area while applying the filter. Those skilled in the art will be familiar with how to include z into this process. For example, z may be simply added to the luminosity before any further filtering takes place.

FIG. 4 shows a sample use of a SAM implementation used to prevent blown out areas during the image editing process. FIG. 4 (top) shows the image without the SAM being used and FIG. 4 (bottom) shows the image with the SAM used to prevent the blown out effect.

Using the SAM for Camera-Specific Noise Reduction

The SAM can be combined with camera-specific noise reduction filters to provide optimized noise reduction and increased control. If this combination is desired, the implementation of the sliders in FIG. 1 can be camera specific. For example, a camera with a uniform noise behavior may require fewer sliders (for example n=3) while a camera that produces noise that is more structure dependent, relative to other cameras, may require a larger number of sliders (for example n=8).

In a further embodiment of the invention, the default settings of the sliders could be made camera-specific. If the camera has a tendency to produce excessive noise in blue areas of an image, the SAM might include a slider with a color field, which is set by default to blue and a slider value which is set by default to a high setting. An implementation for a specific camera is shown in FIG. 2.

Noise and Detail Specific Tools

The use of detail-specific noise reduction and detail enhancement tools are provided in one embodiment of the current invention allowing users to use conventional pointing devices, such as a computer mouse or a pressure sensitive graphics tablet and pen, to apply the prescribed tool. Current applications only allow users to brush-in effects in an image such as a fixed color, a darkening or a lightening effect, a sharpening or a blurring effect.

With reference to FIG. 3, one embodiment of the current invention provides detail specific filters that focus on individual types of detail in order to protect specific details in the noise reduction process. By focusing on specific details that occur in most images, a specific process can be created for selective noise reduction that considers specific detail types. A variety of detail specific noise reducers can be designed, such as one designed for sky details, background details, skin details, and shadow details, for example. The noise reduction filter (in other embodiments other filters could be used) can then be brushed-in using a user pointing device 36.

With reference to FIG. 8, a digital image can then be processed by method 20:

11′) provide an image processing filter 17′;

12′) receive a target image characteristic;

18) receive a coordinate from a user pointing device 36;

14′) determine for each pixel to be processed, the correspondence between the characteristics 16′ of that pixel, the target image characteristic, and the received coordinates.

15′) process the digital image by applying the image processing filter 17′ as a function of the determined correspondence between each pixel the target image characteristic, and the received coordinates.

Creating Noise Brushes for Different Image Structures and Details

In order to create a detail-specific noise reduction filter, a general noise reduction algorithm is required which differentiates between chrominance and luminance and different frequencies. For example, a filter could have one parameter for small noise, for noise of intermediate sizes, and for large noise. If a filter based on a Laplace pyramid, Wavelets, or Fourier analysis is used, those skilled in the art will know how to create a noise reduction filter that differentiates between various frequencies/bands. The filter may also accept different parameters for the luminance noise reduction strength versus chrominance noise reduction strength. If this is done, the filter will be able to accept a few different parameters:

TABLE 1

| | | |
|---|---|---|
| High Frequencies/ | Medium Freq./ | Low Freq./ |
| Luminance | Luminance | Luminance |
| High Freq./ | Medium Freq./ | Low Freq./ |
| Chrominance | Chrominance | Chrominance |

For best results, locate a suitable combination of such parameters.

It is possible to correlate these target image characteristics to specific enhancement algorithms using heuristic methods. For example, using a plurality of images, select-one image structure type, such as sky, skin, or background. Using trial and error, experiment with different values for the noise reducer on all of the images to determine the optimal combination for the noise reduction for this structure type. For example, for the structure type background, the following-parameters might be suitable:

TABLE 2

| | | |
|---|---|---|
| 100% | 100% | 100% |
| 100% | 100% | 100% |

Since the background of an image is typically out-of-focus and therefore blurry, it is acceptable to reduce both chrominance and luminance noise to a strong degree. On the other hand, the structure type sky might have the following parameters:

TABLE 3

| | | |
|---|---|---|
| 25% | 50% | 75% |
| 100% | 100% | 100% |

This combination would be suitable as sky often contains very fine cloud details. To maintain these details, the first table entry (high frequencies/luminance) is set to 25% only. However, as sky consists mostly of very large areas, it is important that the low frequencies are reduced to a rather large extent, so that the sky does not contain any large irregularities. Because of this, the third table entry is set to 75%. The lower three table entries, which cover the chrominance noise, are all set to 100%, as sky has a rather uniformly blue color, against which color irregularities can be seen very well.

Treating Chrominance and Luminance Noise

One embodiment of the current invention provides a range of options for optimally reducing chrominance noise (noise that consists of some degree of color) and luminance noise (noise with no appearance of color) in a digital image. The system described employs a range of techniques while using an approach that splits the image into one luminance channel (C1) and two chrominance channels (C2 and C3). The process of splitting the chrominance information from the luminance information in the image may be performed in a constant fashion or using a camera-dependent implementation.

Splitting the Image in Chrominance and Luminance

To gain the channels C₁, C₂, and C₃, the image can be transformed either into “Lab” or “YCrCb” mode, or in an individual fashion, where C₁ could be calculated as x₁r+x₂g+x₃b, all x being positive. While doing so, it is important that a set of x₁ . . . x₃ is found which leads to a channel C₁ that contains the least possible chrominance noise. To do so, take an image containing a significant amount of chrominance noise and find a set of x₁ . . . x₃ where the grayscale image C₁ has the least noise. Finding the set of x₁ . . . x₃ with trial and error is an appropriate approach To obtain the image channels C₂ and C₃, two further triples of numbers y₁ . . . y₃ and z₁ . . . z₃ are required, where all three sets must be linear independent. If the matrix [x, y, z] were linear dependent it would not be possible to regain the original image colors out of the information C₁ . . . C₃ after the noise reduction were performed. Find values for y₁ . . . y₃ and z₁ . . . z₃ so that the resulting channels C₂ and C₃ contain the least luminance information (the image should not look like a grayscale version of the original) and the most chrominance noise (the color structures of the original should manifest themselves as a grayscale pattern of maximal contrast in the channels C₂ and C₃). The two triples (−1,1,0) and (0,−1,−1) are good values to start with. If the user interface or system involves a step that requests information from the user on what digital camera/digital chip/recording process is used, it may preferable to adjust the three triples x₁ . . . x₃ . . . z₁ . . . z₃ based on the camera If a camera produces a predominant amount of noise in the blue channel, it may be preferable to set x₃ to a low value. If it has the most noise in the red channel, for instance with multiple-sensor-per-pixel chips, it may make sense to set x₁<x₃.

System

Preferably, the invention will be embodied in a computer program (not shown) either by coding in a high level language, or by preparing a filter which is complied and available as an adjunct to an image processing program. For example, in a preferred embodiment, the SAM is compiled into a plug-in filter that can operate within third party image processing programs, such as Photoshop®. It could also be implemented in a stand alone program, or in hardware, such as digital cameras.

Any currently existing or future developed computer readable medium suitable for storing data can be used to store the programs embodying the afore-described methods and algorithms, including, but not limited to hard drives, floppy disks, digital tape, flash cards, compact discs, and DVDs. The computer readable medium can comprise more than one device, such as two linked hard drives. This invention is not limited to the particular hardware used herein, and any hardware presently existing or developed in the future that permits image processing can be used.

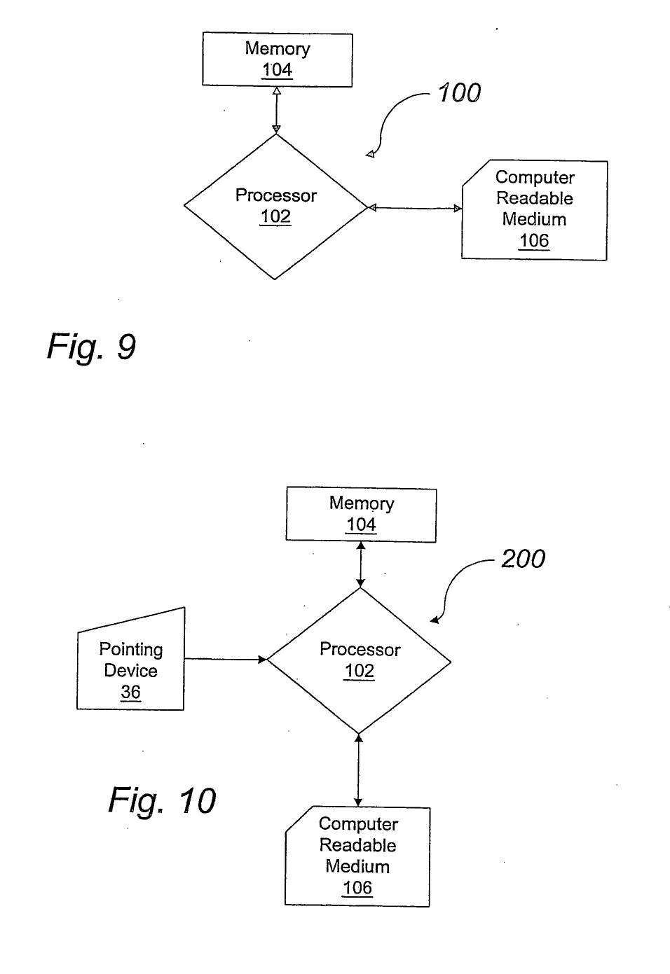

With reference to FIG. 9, one embodiment of a system 100 of the present invention comprises a processor 102, a memory 104 in communication with the processor 102, and a computer readable medium 106 in communication with the processor 102, having contents for causing the processor 102 to perform the steps of one of the embodiments of the method 10 of FIG. 7. With reference to FIG. 10, a further embodiment of a system 200 of the present invention comprises a processor 102, a memory 104 in communication with the processor 102, a user pointing device 36, and a computer readable medium 106 in communication with the processor 102, having contents for causing the processor 102 to perform the steps of one of the embodiments of the method 20 of FIG. 8.

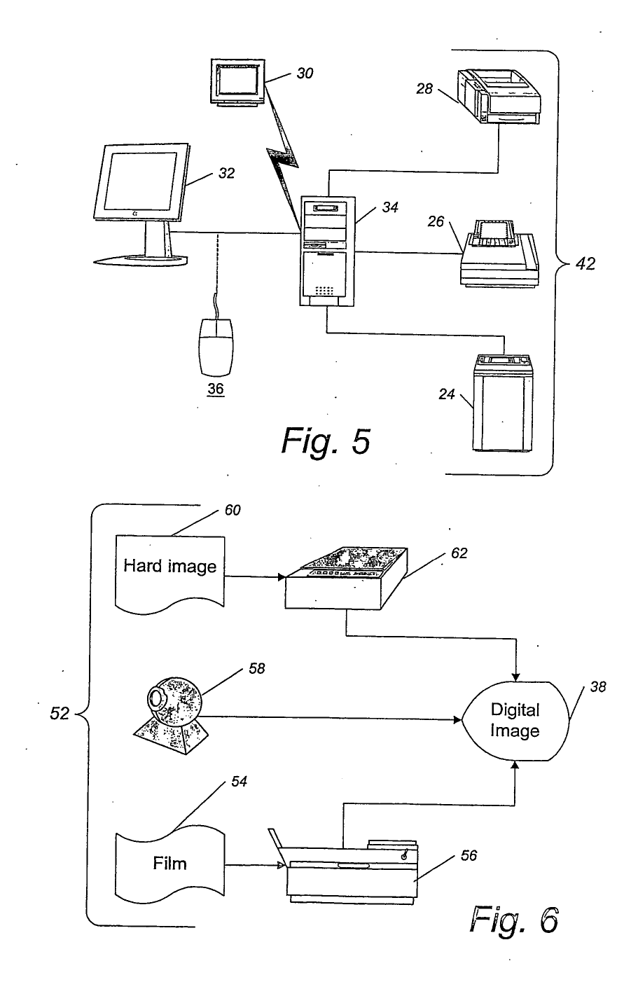

With reference to FIG. 5 and FIG. 6, one hardware configuration useable to practice various embodiments of the method of the invention comprises a computer monitor 32 and computer CPU 34 comprising processor 102 and memory 104, program instructions on computer readable medium 106 for executing one of the embodiments of method 10 or method 20 on a digital image 38, for output on one or more than one printer type 42, or a digital display device 30 through the Internet. In at least one embodiment a user-pointing device 36 provides coordinate information to CPU 34. Various pointing devices could be used, including pens, mice, etc. As will be evident to those skilled in the art with reference to this disclosure, various combinations of printer type 42 or digital display device 30 will be possible.

Digital image 38 could be obtained from various image sources 52, including but not limited to film 54 scanned through a film scanner 56, a digital camera 58, or a hard image 60 scanned through an image scanner 62. It would be possible to combine various components, for example, integrating computer monitor 32 and computer CPU 34 with digital camera 58, film scanner 56, or image scanner 62.

In one embodiment, it is possible to have the program instructions query the components of the system, including but not limited to any image processing program being used, or printer being used, to determine default settings for such programs and devices, and use those parameters as the inputs into the SAM. These parameters may automatically be determined without operator intervention, and set as the defaults for the system. Depending upon the particular needs, these defaults may be further changeable by operator intervention, or not.

It is to be understood that in this disclosure a reference to receiving parameters includes such automated receiving means and is not to be limited to receiving by operator input. The receiving of parameters will therefore be accomplished by a module, which may be a combination of software and hardware, to receive the parameters either by operator input, by way of example through a digital display device 32 interface, by automatic determination of defaults as described, or by a combination.

The enhanced digital image is then stored in a memory block in a data storage device within computer CPU 34 and may be printed on one or more printers, transmitted over the Internet, or stored for later printing.

In the foregoing specification, the invention has been described with reference to specific embodiments thereof. It will, however, be evident that various modifications and changes may be made thereto without departing from the broader spirit and scope of the invention. The specification and drawing are, accordingly, to be regarded in an illustrative rather than a restrictive sense. It should be appreciated that the present invention should not be construed as limited by such embodiments, but rather construed according to the below claims.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

This invention is not limited to particular hardware described herein, and any hardware presently existing or developed in the future that permits processing of digital images using the method disclosed can be used, including for example, a digital camera system-L

Any currently existing or future developed computer readable medium suitable for storing data can be used, including, but not limited to hard drives, floppy disks, digital tape, flash cards, compact discs, and DVDs. The computer readable medium can comprise more than one device, such as two linked hard drives, in communication with the processor.

Also, any element in a claim that does not explicitly state “means for” performing a specified function or “step for” performing a specified function, should not be interpreted as a “means” or “step” clause as specified in 35 U.S.C. § 112.

It will also be understood that the term “comprises” (or it grammatical variants) as used in this specification is equivalent to the term includes” and should not be taken as excluding the presence of other elements or features.

1. A method for image processing of a digital image comprising pixels having characteristics, comprising applying an image processing filter as a function of the characteristics of each pixel to be processed, a first set of target image characteristics, a first received adjustment parameter associated with the first set of target image characteristics, a second set of target image characteristics, and a second received adjustment parameter associated with the second set of target image characteristics.

2. The method of claim 1, where either the first set of target image characteristics, or the second set of target image characteristics, or both, are received.

3. The method of claim 1 wherein the image processing filter is a noise reduction filter, a sharpening filter, or a color change filter.

4. The method of claim 1 further comprising receiving one or more third sets of target image characteristics, and one or more third adjustment parameters, each of the third adjustment parameters being associated with one of the third sets of target image characteristics, and wherein the application of the image processing filter is also a function of the one or more third sets of target image characteristics, and the associated third adjustment parameters.

5. The method of claim 1 where either, or both, of the received adjustment parameters is an opacity parameter or a luminosity parameter.

6. The method of claim 1 further comprising the step of providing a graphic user interface for receiving the first set of target image characteristics, the second set of target image characteristics, the first adjustment parameter, and the second adjustment parameter.

7. The method of claim 6, where the graphic user interface for receiving either of the adjustment parameters comprises a slider.

8. The method of claim 1 wherein the first set of target image characteristics, or the second set of target image characteristics, comprises an image coordinate, a color, or an image structure.

9. (canceled)

10. The method of claim 6, where the graphic user interface comprises indicia representing target image characteristics.

11. The method of claim 6, where the graphic user interface comprises a tool to determine the pixel characteristics of an image pixel.

12. The method of claim 1 further comprising the step of providing camera-specific default settings.

13. A graphic user interface embodied on a computer-readable medium for execution on a computer for image processing of a digital image, the digital image comprising pixels having characteristics, comprising:
a first interface to receive a first set of target image characteristics;
a second interface to receive a second set of target image characteristics;
a third interface to receive a first adjustment parameter associated with the first set of target image characteristics; and
a fourth interface to receive a second adjustment parameter associated with the second set of target image characteristics.

14. The graphic user interface of claim 13, further comprising a fifth interface comprising indicia representing the first set of target image characteristics, and a sixth interface comprising indicia representing the second set of target image characteristics.

15. The graphic user interface of claim 13, further comprising a tool to determine the pixel characteristics of an image pixel.

16. The graphic user interface of claim 13, where the third interface and the fourth interface each comprise a slider.

17. A system for image processing of a digital image, the digital image comprising pixels having characteristics, comprising:
a processor,
a memory in communication with the processor, and
a computer readable medium in communication with the processor, the computer readable medium having contents for causing the processor to perform the steps of:
receiving a first set of target image characteristics;
receiving a first adjustment parameter associated with the first set of target image characteristics;
receiving a second set of target image characteristics;
receiving a second adjustment parameter associated with the second set of target image characteristics;
determining for each pixel to be processed, the correspondence between the characteristics of that pixel, the first set of target image characteristics, and
second set of target image characteristics; and
processing the digital image by applying the image processing filter as a function of the determined correspondence, the first received adjustment parameter, and the second received adjustment parameter.

18. The system of claim 17, the computer readable medium further having contents for causing the processor to perform the steps of receiving one or more third sets of target image characteristics, and one or more third adjustment parameters, each of the third adjustment parameters being associated with one of the third sets of target image characteristics, and the processing step further comprising applying the image processing filter as a function of the one or more third sets of target image characteristics, and the one or more associated third adjustment parameters.

19. The system of claim 17, further comprising a set of camera-specific default instructions embodied on a computer-readable medium for execution on a computer.

20. A set of camera-specific default instructions embodied on a computer-readable medium for execution on a computer for image processing of a digital image, using the method of claim 1.

21. A set of camera-specific default instructions for setting the state of the graphic user interface of claim 13, embodied on a computer-readable medium for execution on a computer.

22-31. (canceled)
